(19) United States
(12) Patent Application Publication
(10) Pub. No.: US 2026/0312142 A1
(43) Pub. Date: Oct. 8, 2026

(54) Electrode Assembly and Secondary Battery including the Same

(71) Applicant: SAMSUNG SDI CO., LTD, Yongin-si, Gyeonggi-do (KR)

(72) Inventors: Mi Sol KIM, Yongin-si, Gyeonggi-do (KR); KwangSoo BAE, Yongin-si, Gyeonggi-do (KR)

(21) Appl. No.: 19/194,451

(22) Filed: Apr. 30, 2025

(30) Foreign Application Priority Data
Nov. 7, 2024 (KR) 10-2024-0141755

(51) Int. Cl. H01M 10/0585; B60L 50/64; H01M 50/46; H01M 50/463

(52) U.S. Cl. CPC H01M 10/0585; H01M 50/46; H01M 50/463; B60L 50/64

(57) ABSTRACT

An electrode assembly includes a plurality of electrode parts including a first electrode plate, a second electrode plate, and a separator, and a fixing member surrounding the plurality of electrode parts, wherein the plurality of electrode parts have a meandering angle of 0.1° or less, and wherein the meandering angle is an angle at which a lowermost electrode plate and an uppermost electrode plate of the electrode parts are misaligned.

### CROSS-REFERENCE TO THE RELATED APPLICATION

The present application claims priority to and the benefit of Korean Patent Application No. 10-2024-0141755, filed on Oct. 17, 2024, in the Korean Intellectual Property Office, the entire disclosure of which is incorporated herein by reference.

### BACKGROUND

### 1. Field

Embodiments relate to an electrode assembly and a secondary battery including the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments include an electrode assembly, including a plurality of electrode parts including a first electrode plate, a second electrode plate, and a separator, and a fixing member surrounding the plurality of electrode parts, wherein the plurality of electrode parts have a meandering angle of 0.1° or less, and wherein the meandering angle is an angle at which a lowermost electrode plate and an uppermost electrode plate of the plurality of electrode parts are misaligned.

The plurality of electrode parts may include a first electrode part, a second electrode part on the first electrode part, and a third electrode part on the second electrode part, wherein the first electrode part may include a first electrode plate, a second electrode plate, and a first separator between the first electrode plate and the second electrode plate, wherein the second electrode part includes a third electrode plate, a fourth electrode plate, and a second separator between the third electrode plate and the fourth electrode plate, wherein the third electrode part includes a fifth electrode plate, a sixth electrode plate, and a third separator between the fifth electrode plate and the sixth electrode plate, and wherein the meandering angles of the first electrode part, the second electrode part, and the third electrode part are different from each other.

The electrode assembly may comprise an overlapping separator, and a thickness of the overlapping separator may be greater than a thickness of another separator of the first separator, the second separator and the third separator.

The overlapping separator may be formed separators of different electrode parts.

The overlapping separator is in a boundary region of the electrode parts.

The first separator may include a first separator part and a second separator part, and wherein the second separator includes a third separator part and a fourth separator part, the third separator includes a fifth separator part and a sixth separator part, the first separator part, the third separator part and the fifth separator part are disposed between the first electrode plate and the second electrode plate, wherein the second separator part, the fourth separator part and the sixth separator part are on side surfaces of the first electrode plate and the second electrode plate, resulting in separator parts, and wherein at least two separator parts among the second separator part, the fourth separator part and the sixth separator part form a side overlapping separator.

A length of the side overlapping separator may be longer than a length of other of the separator parts.

The side overlapping separator may be on a boundary region of the plurality of electrode parts.

The first electrode part, the second electrode part, and the third electrode part are formed by the same stacking process.

The first electrode part, the second electrode part, and the third electrode part may be stacked in a Z stack.

The first electrode part and the third electrode part may be outer electrode parts, the second electrode part may be an inner electrode part, and the first electrode part and the third electrode part are formed by a stacking process different from the second electrode part.

The first electrode part and the third electrode part may be stacked, and the second electrode part may be stacked in a Z stack.

The first electrode part and the third electrode part may be stacked in a Z stack, and the second electrode part is stacked.

The first electrode part may have a first thickness, the second electrode part may have a second thickness, the third electrode part may have a third thickness, and the first thickness, the second thickness, and the third thickness are different.

Thicknesses of the plurality of electrode parts may decrease or increase while extending from the first electrode part toward the third electrode part.

At least one electrode part may have a material of a separator, a material of an electrode current collector, or an electrode active material different from other of the plurality of electrode parts.

Meandering angles of the plurality of electrode parts may decrease or increase while extending from the first electrode part toward the third electrode part.

The electrode assembly may include a region in which a meandering direction of the plurality of electrode parts changes while extending from the first electrode part toward the third electrode part.

The electrode assembly may have a thickness of 40 mm to 50 mm.

Embodiments include a secondary battery, including a case, and the electrode assembly of this disclosure is accommodated in the case.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings.

Features will become apparent to those of ordinary skill in the art by describing in detail exemplary embodiments with reference to the attached drawings, in which:

FIG. 1 is a perspective view showing an electrode assembly according to an embodiment;

FIG. 2 is a cross-sectional view taken along the A-A′ section of FIG. 1;

FIG. 3 is a cross-sectional view of an electrode part of the electrode assembly according to the embodiment;

FIG. 4 is a drawing explaining a manufacturing method of the electrode assembly according to the embodiment;

FIGS. 5A and 5C are drawings explaining a meandering of the electrode assembly according to the embodiment;

FIG. 6 is a drawing explaining a manufacturing process of the electrode assembly according to the embodiment;

FIGS. 7 to 11 are cross-sectional views of the electrode assembly according to the embodiment;

FIG. 12 is a drawing explaining a size of the electrode assembly according to the embodiment;

FIGS. 13A and 13B are drawings explaining a meandering of the electrode assembly according to an embodiment;

FIGS. 14 and 15 are drawings explaining a secondary battery to which an electrode assembly according to the embodiment is applied;

FIG. 16 is a perspective view showing a battery module including battery cells according to some embodiments;

FIGS. 17 and 18 are perspective views showing a battery pack including battery modules according to some embodiments; and

FIGS. 19 and 20 are a perspective view and a side view, respectively, showing a vehicle including battery packs according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. §112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, an electrode assembly according to an embodiment will be described with reference to the drawings.

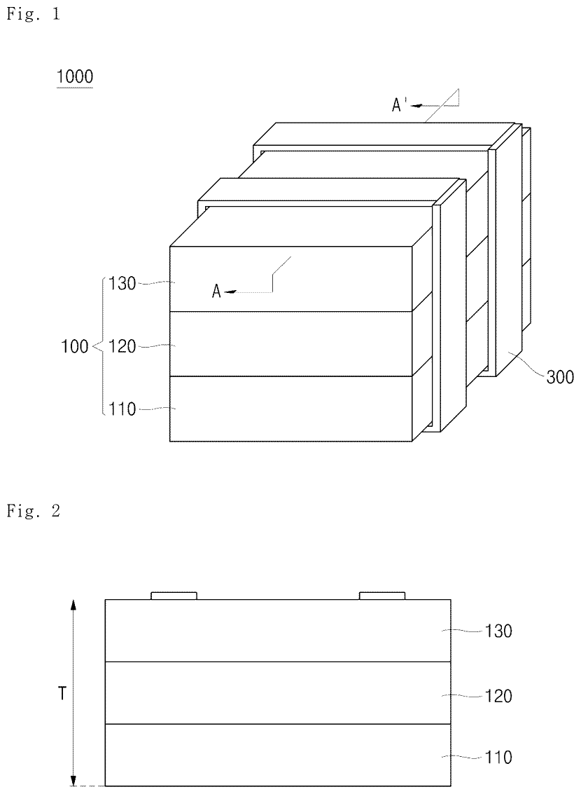

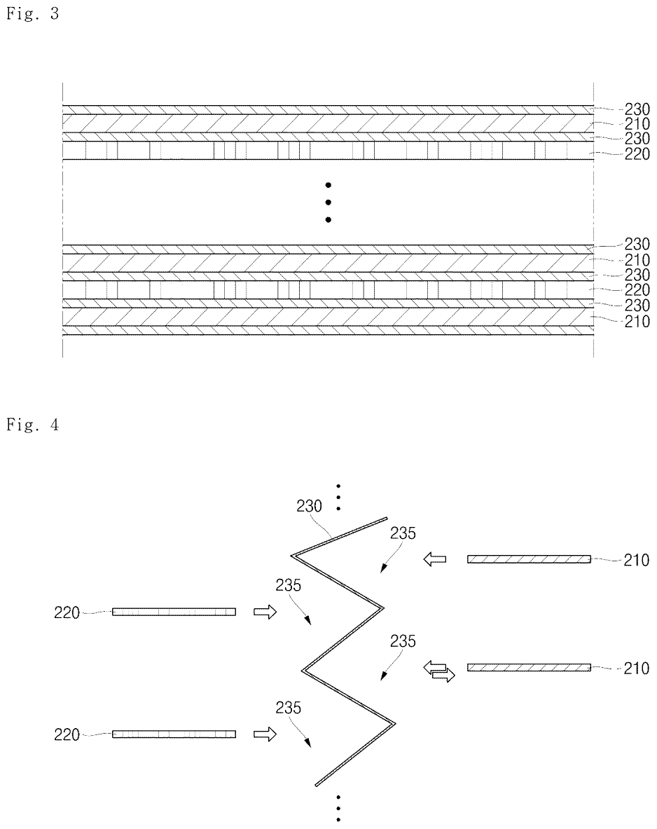

Referring to FIGS. 1 and 2, the electrode assembly 1000 may include a plurality of electrode parts and a fixing member 300. The electrode part 100 may include a plurality of electrode parts. For example, the electrode part 100 may include a first electrode part 110, a second electrode part 120, and a third electrode part 130.

The first electrode part 110, the second electrode part 120, and the third electrode part 130 may be sequentially stacked. For example, the second electrode part 120 may be disposed on the first electrode part 110 and the third electrode part 130 may be disposed on the second electrode part 120. Although the drawing illustrates three electrode parts, the electrode part may include four or more electrode parts. The number of the electrode parts may vary depending on the size of the electrode assembly or the meandering characteristics of the electrode assembly.

The electrode assembly 1000 may have a set size (e.g., a predetermined size). For example, the thickness T of the electrode assembly may be 40 mm or more. For example, the thickness T of the electrode assembly may be 40 mm to 50 mm.

The first electrode part 110, the second electrode part 120, and the third electrode part 130 may be formed by different processes. The processes of the first electrode part 110, the second electrode part 120, and the third electrode part 130 are described below.

The fixing member 300 may surround the electrode parts. For example, the fixing member 300 may be disposed on the upper surface, lower surface, and side surfaces of the electrode part 100. Accordingly, a plurality of electrode parts may be fixed by the fixing member 300. The fixing member 300 may include a resin material. For example, the fixing member 300 may include a tape. The fixing member 300 may include at least one fixing member. The number of the fixing members 300 may vary depending on the size of the electrode assembly.

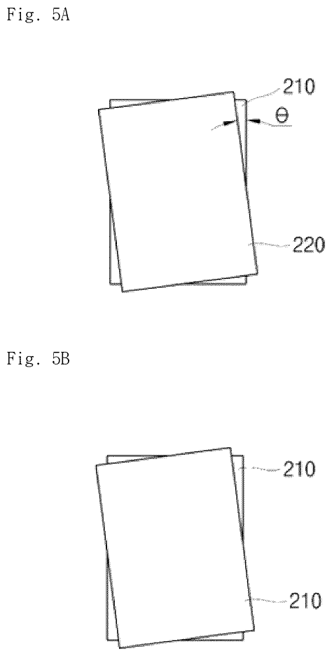

FIG. 3 is a cross-sectional view of one electrode part. Referring to FIG. 3, the electrode part may include a first electrode plate 210, a second electrode plate 220, and a separator 230 therebetween. The first electrode plate 210, the second electrode plate 220, and the separator 230 may be formed by being laminated. For example, the electrode part may be a stack electrode part laminated in a stacking manner. As another example, the electrode part may be a Z-stack electrode part in which the first electrode plate 210 and the second electrode plate 220 are inserted on both sides of a separator 230 folded in a Z-stack. The first electrode plate 210 may be a negative electrode, and the second electrode plate 220 may be a positive electrode. The opposite is also possible.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator prevents a short circuit between the first electrode plate and the second electrode plate while allowing movement of lithium ions therebetween. The separator may be made of, for example, a polyethylene film, a polypropylene film, a polyethylene-polypropylene film, or the like.

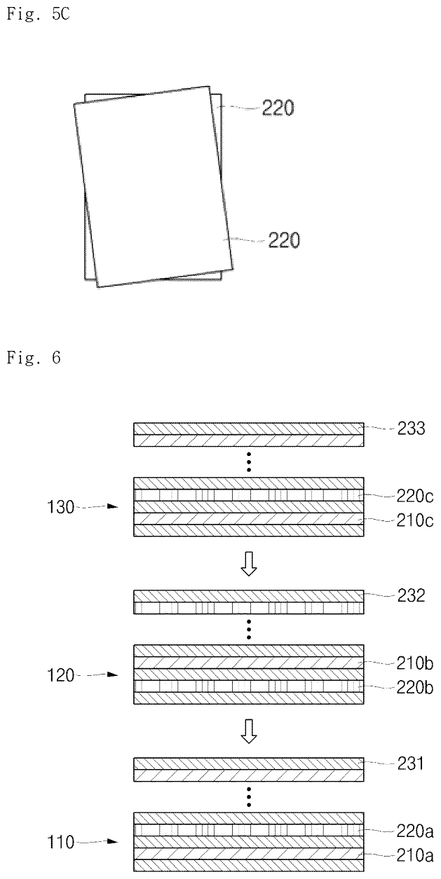

Referring to FIG. 4, the electrode assembly may be formed by a Z-stacking process. In detail, the separator 230 may be folded while having a plurality of folded portions. Accordingly, the separator 230 may include a plurality of insert portions 235 formed by the plurality of folded portions. The first electrode plate 210 and the second electrode plate 220 may be inserted into the insert portions 235, respectively. For example, the first electrode plate 210 and the second electrode plate 220 may be inserted alternately. For example, the first electrode plate 210 and the second electrode plate 220 may be inserted into the insert portions 235 using a jig.

Next, pressure may be applied to the separator. Accordingly, the electrode assembly may be formed. As described above, the first electrode plate 210 and the second electrode plate 220 may be inserted using their respective jigs. Accordingly, the alignment of the electrode plates may be misaligned due to an error during the stacking process. Accordingly, a meandering defect of the electrode assembly may occur. The meandering defect may increase as the size of the electrode plate or the thickness of the electrode assembly increases.

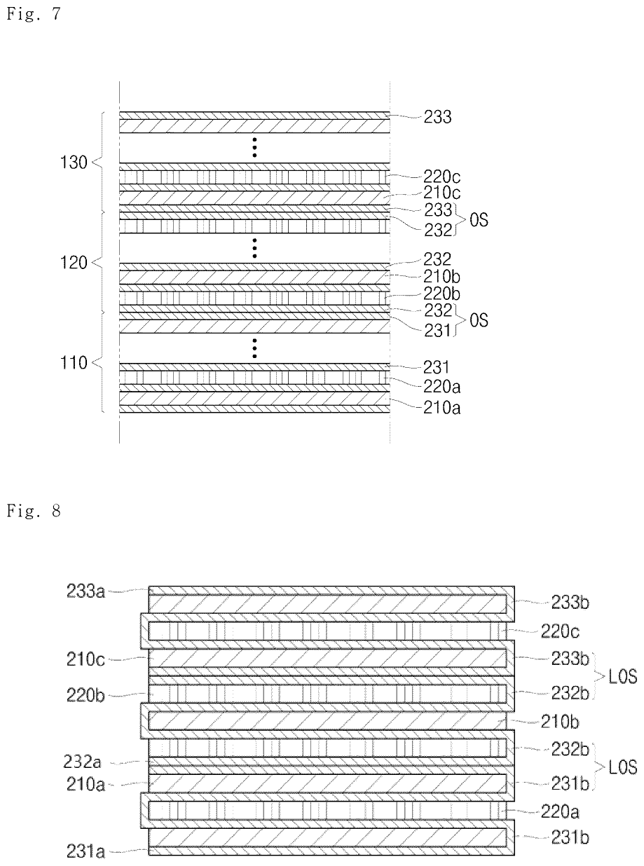

FIG. 5 is a drawing explaining the meandering defect of the electrode assembly. Referring to FIG. 5A, the lowermost electrode plate of the electrode assembly may be the first electrode plate 210, and the uppermost electrode plate may be the second electrode plate 220. Referring to FIG. 5B, the lowermost electrode plate and the uppermost electrode plate may be the first electrode plate 210. Referring to FIG. 5C, the lowermost electrode plate and the uppermost electrode plate may each be a second electrode plate 220. The lowermost electrode plate and the uppermost electrode plate may be misaligned due to an error during the stacking process. For example, the lowermost electrode plate and the uppermost electrode plate may be misaligned at a meandering angle θ. Accordingly, the unreacted region of the electrode assembly may increase, and thus, the charge/discharge characteristics of the electrode assembly may decrease.

The electrode assembly according to the embodiment may include a plurality of electrode parts. Each electrode part may be formed by the same or different stacking processes. For example, at least one electrode part may be formed by a Z-stacking process. And, at least one electrode part may be formed by a stacking process (e.g., non-Z-stacking process). The stacking process may be a process of stacking a plurality of sub-electrode parts in which a first electrode plate, a separator, and a second electrode plate are stacked. Each electrode part may be formed by a different process. That is, each electrode part may not be formed simultaneously with the same equipment.

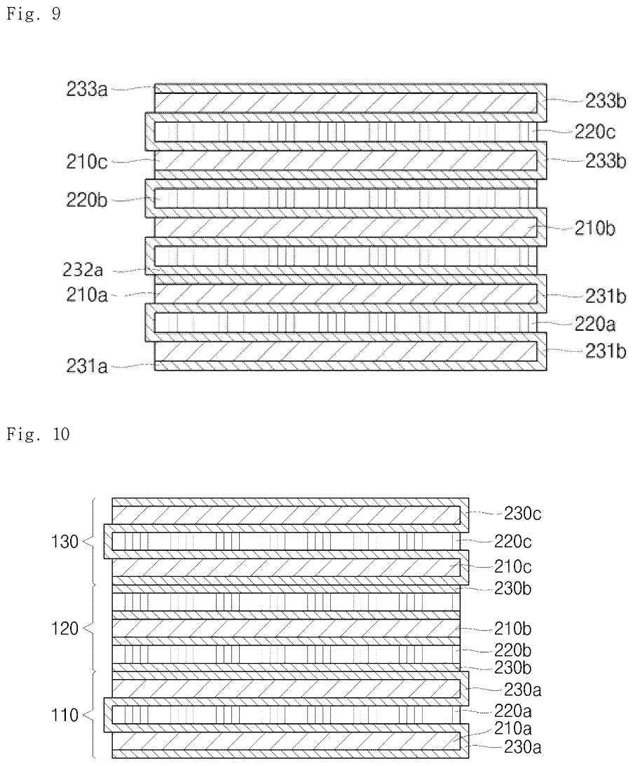

FIG. 6 is a drawing explaining a manufacturing process of the electrode assembly according to the embodiment. Referring to FIG. 6, the first electrode part 110, the second electrode part 120, and the third electrode part 130 may be formed respectively. The first electrode part 110, the second electrode part 120, and the third electrode part 130 may be formed by the same or different stacking processes. For example, the first electrode part 110, the second electrode part 120, and the third electrode part 130 may be formed by a Z-stacking process. As another example, at least one of the first electrode part 110, the second electrode part 120, or the third electrode part 130 may be formed by a Z-stacking process, and the rest may be formed by a stacking process.

The first electrode part 110 may include a first electrode plate 210a (e.g., a first electrode plate), a second electrode plate 220a (e.g., a second electrode plate), and a first separator 231. The first separator 231 may be disposed at the uppermost and lowermost portions of the first electrode part 110. The second electrode part 120 may include a third electrode plate 210b (e.g., a third electrode plate), a fourth electrode plate 220b (e.g., a fourth electrode plate), and a second separator 232. The second separator 232 may be disposed at the uppermost and lowermost portions of the second electrode part 120. The third electrode part 130 may include a fifth electrode plate 210c (e.g., a fifth electrode plate), a sixth electrode plate 220c (e.g., a sixth electrode plate), and a third separator 233. The third separator 233 may be disposed at the uppermost and lowermost portions of the third part 130.

Next, the first electrode part 110, the second electrode part 120, and the third electrode part 130 may be disposed sequentially. For example, the second electrode part 120 may be disposed on the first electrode part 110, and the third electrode part 130 may be disposed on the second electrode part 120. Accordingly, the electrode assembly may be formed.

The electrode assembly may include a plurality of electrode parts. That is, the electrode assembly may be formed by stacking a plurality of electrode parts. The plurality of electrode parts may be formed individually. Accordingly, even if the thickness of the electrode assembly increases, the meandering defect of the electrode assembly may be prevented. In detail, as the thickness of the electrode assembly increases, the alignment characteristic may decrease. For example, the alignment characteristic of the electrode assembly may decrease as it extends from the bottom to the top. Accordingly, the meandering angle θ of the electrode assembly may increase as the thickness of the electrode assembly increases.

The electrode assembly according to the embodiment includes a plurality of electrode parts. Accordingly, the meandering angle of each electrode part may decrease. In detail, since the thickness of the electrode part is smaller than the thickness of the electrode assembly, the meandering angle of each electrode part may decrease. Accordingly, the meandering angle of the electrode assembly formed by stacking the electrode parts may also decrease. Accordingly, the electrode assembly according to the embodiment may have improved alignment characteristics. For example, the meandering angle of the plurality of electrode parts may be 0.1° or less. Accordingly, the meandering angle of the electrode assembly may be controlled to 0.1° or less. Accordingly, the electrode assembly according to the embodiment may have improved charge/discharge characteristics.

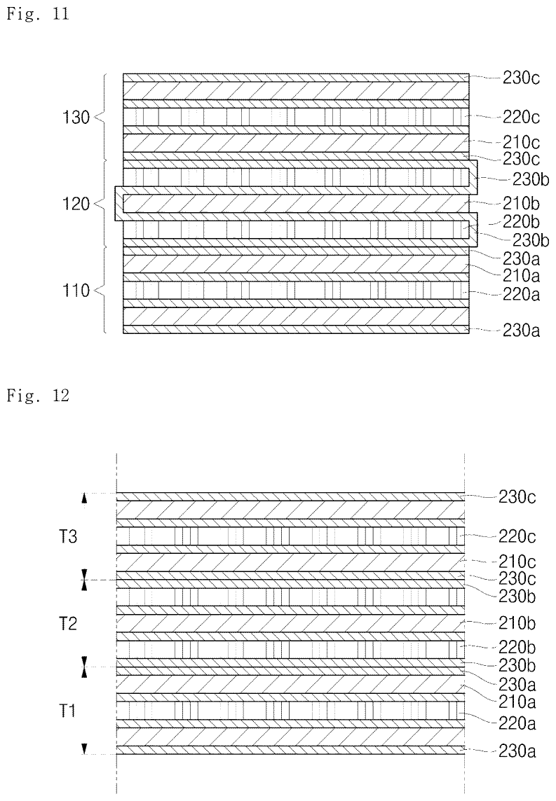

FIGS. 7 to 11 are cross-sectional views of the electrode assembly according to various embodiments. Referring to FIG. 7, the electrode assembly may include an overlapping separator OS. The overlapping separator OS may be formed by a plurality of separators. In detail, the overlapping separator OS may be formed by overlapping separators of different electrode parts. For example, when the electrode assembly includes three electrode parts, the electrode assembly may include two overlapping separators. For example, one overlapping separator OS may be formed by overlapping the first separator 231 and the second separator 232. Another overlapping separator OS may be formed by overlapping the second separator 232 and the third separator 233. Accordingly, the thickness of the overlapping separator OS may be greater than the thickness of the other (e.g., first, second or third) separator.

The thickness of the overlapping separator OS may be greater than the thickness of the other separator. Therefore, the boundary of the electrode parts may be easily identified by the overlapping separator OS. Therefore, after the electrode parts are laminated, the electrode part determined to be defective may be easily identified. For example, the electrode part may be damaged during the process of laminating the electrode parts or the meandering angle of the electrode part may increase. In this case, the electrode part determined to be defective may be easily distinguished by the overlapping separator. Therefore, the electrode part determined to be defective may be easily replaced.

Referring to FIG. 8, the separator may be separated into two regions depending on the location. For example, the first separator may include a first separator part 231a and a second separator part 231b. And, the second separator may include a third separator part 232a and a fourth separator part 232b. The third separator may include a fifth separator 233a part and a sixth separator part 233b.

The first separator part 231a, the third separator part 232a, and the fifth separator part 233a may be disposed to face each other. For example, the first separator part 231a, the third separator part 232a, and the fifth separator part 233a may face each other in the thickness direction of the electrode plates. The first separator part 231a, the third separator part 232a, and the fifth separator part 233a may be disposed between the electrode plates.

The second separator part 231b, the fourth separator part 232b, and the sixth separator part 233b may be disposed on a side surface of the electrode plates. That is, the second separator part 231b, the fourth separator part 232b, and the sixth separator part 233b may be side separators. When the electrode parts are formed by a Z-stacking process, the separator may be disposed while surrounding one side of the electrode plate. Accordingly, the second separator part 231b, the fourth separator part 232b, and the sixth separator part 233b may be formed.

The separator may include a side overlapping separator LOS. The side overlapping separator LOS may be formed by a plurality of separators. In detail, the side overlapping separator LOS may be formed by side separators of different electrode parts. For example, when the electrode assembly includes three electrode parts, the electrode assembly may include two side overlapping separators. For example, one side overlapping separator LOS may be formed by overlapping the second separator part 231b and the fourth separator part 232b. And, another side overlapping separator LOS may be formed by overlapping the fourth separator part 232b and the sixth separator part 233b. Accordingly, the length of the side overlapping separator LOS may be longer than the length of the other side separator.

The length of the side overlapping separator LOS is longer than the length of the other side separator. Therefore, the boundary of the electrode parts may be easily confirmed by the side overlapping separator LOS. Therefore, after stacking the electrode portions, the electrode part determined to be defective may be easily confirmed. For example, the electrode part may be damaged during the process of stacking the electrode part, or the meandering angle of the electrode part may increase. In this case, the electrode parts determined to be defective may be easily distinguished by the side overlapping separator. Therefore, the electrode parts determined to be defective may be easily replaced.

In addition, the boundary region of the electrode parts may be weaker in rigidity compared to other regions. In detail, the boundary region of the electrode parts is a region where different separators are laminated. Accordingly, the boundary region of the electrode parts may be vulnerable to external impact. The side overlapping separator is disposed on the boundary region of the electrode parts. Therefore, the boundary region of the electrode parts may be protected by the side overlapping separator. Therefore, the reliability of the electrode assembly may be improved.

Referring to FIG. 9, the electrode parts may be formed by a Z-stacking process. Accordingly, the separator may surround one side of the electrode plate. Accordingly, the second separator part 231b, the fourth separator part 232b, and the sixth separator part 233b may be formed.

Unlike FIG. 8 described above, the electrode assembly may not include the side overlapping separator. For example, the second electrode part may be laminated by rotating 180°. Accordingly, all of the side separator parts may have the same or similar length.

Accordingly, the side of the electrode assembly may be formed uniformly. Accordingly, when forming a fixing member on the electrode parts, the fixing member may be easily formed. Also, it is possible to prevent or reduce the adhesive strength of the fixing member from being different on both sides of the electrode part. Therefore, after the electrode assembly is formed, the position of the electrode part may be prevented from moving.

Referring to FIGS. 10 and 11, the manufacturing process of at least one of the electrode parts may be different from the manufacturing process of the other electrode parts.

Referring to FIGS. 10 and 11, the first electrode part 110 and the third electrode part 130 may be formed by a different process from the second electrode part 120.

Referring to FIG. 10, the first electrode part 110 and the third electrode part 130 may be formed by the Z-stacking process and the second electrode part 120 may be formed by the stacking process.

Therefore, the shapes of the first electrode part 110 and the third electrode part 130 may be different from the shape of the second electrode part 120. In detail, the first electrode part 110 and the third electrode part 130 may include the second separator part 231b and the sixth separator part 233b, respectively. That is, the first electrode part 110 and the third electrode part 130 may include the side separator. However, the second electrode part 120 may not include the side separator.

Referring to FIG. 11, the first electrode part 110 and the third electrode part 130 may be formed by the stacking process and the second electrode part 120 may be formed by the Z-stacking process.

Therefore, the shape of the first electrode part 110 and the third electrode part 130 may be different from the shape of the second electrode part 120. In detail, the second electrode part 120 may include the fourth separator part 232b. That is, the second electrode part 120 may include the side separator. However, the first electrode part 110 and the third electrode part may not include the side separator.

The first electrode part 110 and the third electrode part 130 may be outer electrode parts of the electrode assembly. The second electrode part 120 may be an inner electrode part of the electrode assembly.

The characteristics of the electrode part may vary depending on the manufacturing method. For example, the capacity, the meandering characteristic, or the size of the electrode part may vary depending on the manufacturing method. Accordingly, when the electrode parts are formed by two or more manufacturing methods, the characteristics of the electrode assembly may be improved. For example, referring to FIG. 10, since the inner electrode part (i.e., the second electrode part 120) of the electrode assembly is formed by the stacking process, the size of the electrode assembly may be reduced and the capacity may be improved. And, since the outer electrode part (i.e., electrode parts 110 and 130) of the electrode assembly is formed by the Z-stacking process, the process efficiency of the electrode assembly may be improved. Referring to FIG. 11, since the outer electrode part (i.e., electrode parts 110 and 130) of the electrode assembly is formed by the stacking process, the meandering characteristics of the electrode assembly may be improved. Further, since the inner electrode part of the electrode assembly is formed by the Z-stacking process, the process efficiency of the electrode assembly may be improved.

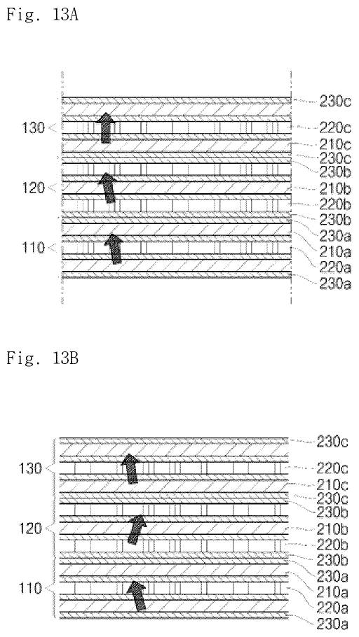

Hereinafter, the electrode parts will be described in detail with reference to FIG. 12.

Referring to FIG. 12, the first electrode part may have a first thickness T1, the second electrode part may have a second thickness T2, and the third electrode part may have a third thickness T3.

The first thickness T1, the second thickness T2, and the third thickness T3 may be the same or similar. In other embodiments, the first thickness T1, the second thickness T2, and the third thickness T3 may be different.

For example, the first thickness T1 and the third thickness T3 may be different from the second thickness T2. That is, the thickness of the outer electrode part may be different from the thickness of the inner electrode part. For example, the first thickness T1 and the third thickness T3 (e.g., each of thicknesses T1 and T3) may be greater than the second thickness T2. As another example, the first thickness T1 and the third thickness T3 may be smaller than the second thickness T2.

The first thickness T1, the second thickness T2, and the third thickness T3 may all be different. For example, the thicknesses of the electrode parts may decrease or increase while extending from (e.g., working up from) the first electrode part toward the third electrode part.

As described above, the electrode parts may be formed by different stacking processes. The characteristics of the electrode parts may vary depending on the stacking process. Therefore, the capacity and the meandering characteristics of the electrode assembly may be improved by forming the thicknesses of the electrode parts differently.

The first electrode part 110, the second electrode part 120, and the third electrode part 130 may include different materials.

For example, the material of the separator of at least one of the electrode parts may be different from the material of the separator of the other electrode parts. In other embodiments, the material of the electrode collector of at least one of the electrode parts may be different from the material of the electrode collector of the other electrode parts. In still other embodiments, the electrode active material of at least one of the electrode parts may be different from the electrode active material of the other electrode parts.

The outer electrode part may be exposed to the outside of the electrode assembly, and the inner electrode part may not be exposed to the outside of the electrode assembly. Accordingly, the electrode part may have different required characteristics depending on the location.

Accordingly, at least one of the separator, the electrode collector, or the electrode active material of at least one of the electrode parts may be different from the other electrode parts. Accordingly, since the electrode part has required characteristics depending on the location, the electrode assembly may have improved electrical characteristics and reliability.

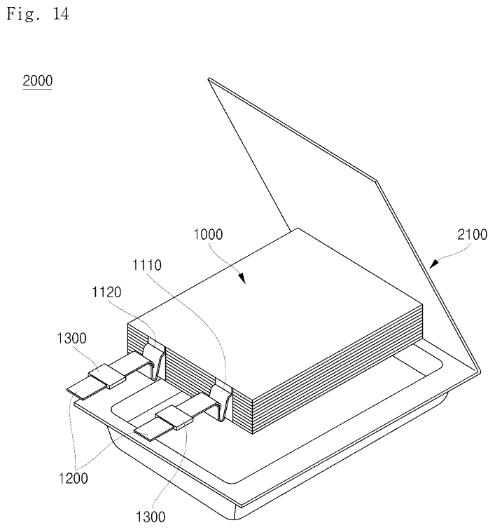

Referring to FIG. 13, the electrode assembly may have various meandering characteristics depending on the position.

Referring to FIG. 13A, the first electrode part 110, the second electrode part 120, and the third electrode part 130 may have different meandering angles depending on the position. The arrows in FIG. 13A mean the meandering angles of each electrode part.

The first electrode part 110, the second electrode part 120, and the third electrode part 130 may have the same or different meandering angles. For example, the meandering angle of the electrode assembly may decrease or increase while extending from (e.g., working up from) the first electrode part 110 toward the third electrode part 130.

Referring to FIG. 13B, the first electrode part 110, the second electrode part 120, and the third electrode part 130 may have different meandering directions depending on the position. The arrows in FIG. 13B mean the meandering directions of each electrode part.

The first electrode part 110, the second electrode part 120, and the third electrode part 130 may have the same or different meandering directions. For example, the meandering direction of the electrode assembly may be the same while extending from the first electrode part 110 toward the third electrode part 130. In other embodiments, the meandering direction of the electrode assembly may be different while extending from the first electrode part 110 toward the third electrode part 130. In still other embodiments, the electrode assembly may include a region in which the meandering direction changes while extending from the first electrode part 110 toward the third electrode part 130.

The electrode assembly according to the embodiment may include a plurality of electrode parts. The size and/or direction of the meandering angle of each electrode part may be different. Accordingly, the meandering defect of the electrode assembly may be prevented. For example, even if the meandering angle of one electrode part increases, the meandering angle of another electrode part may be reduced to offset the meandering angle of one electrode part. In addition, since the meandering directions of the plurality of electrode parts change, the overall meandering angle of the electrode assembly may be reduced. Therefore, the electrode assembly according to the embodiment may have improved meandering characteristics.

The electrode assembly described above may be applied to various types of secondary batteries.

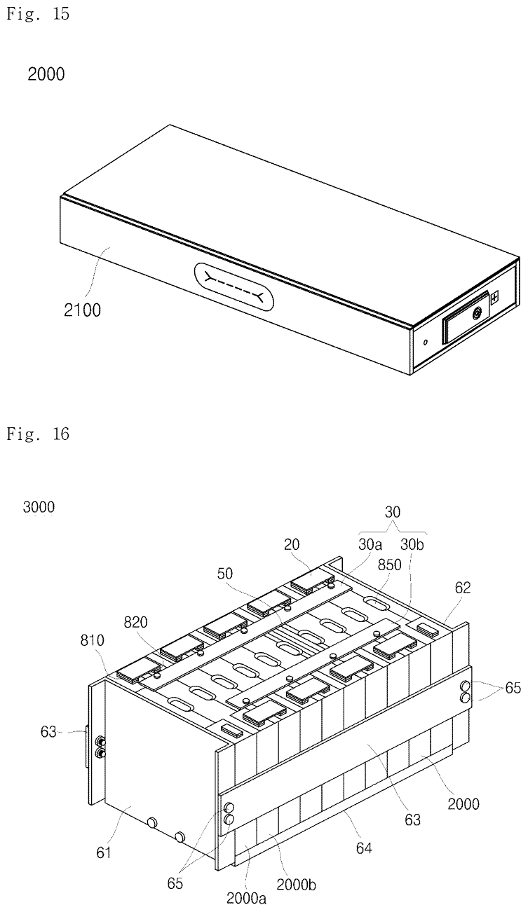

Referring to FIG. 14, the electrode assembly may be applied to a pouch secondary battery.

The secondary battery 2000 may include a case 2100 and the electrode assembly 1000 accommodated in the case 2100. The secondary battery may further include an electrode tab, a lead, and an insulating layer. For example, the electrode tab may include a first electrode tab 1110 connected to the first electrode current collector and a second electrode tab 1120 connected to the second electrode current collector. The first electrode tab 1110 and the second electrode tab 1120 may be each coupled to the electrode current collector by welding. In other embodiments, the first electrode tab 1110 and the second electrode tab 1120 may be formed integrally with the electrode current collector.

The first electrode tab 1110 and the second electrode tab 1120 may each be connected to a lead 1200. The insulating layer 1300 may be disposed on one region of the lead 1200. The lead 1200 and the case 2100 may be insulated by the insulating layer 1300.

Referring to FIG. 15, the secondary battery may include a case (2100) and the electrode assembly disposed in the case. The secondary battery may be prismatic battery. The electrode assembly may be connected to a terminal part by at least one of the electrode tab or the lead. The terminal part may be connected to an external terminal.

The secondary battery may be used in portable small electronic devices such as smart phones, notebook computers, digital cameras, and camcorders. And, a battery module and a battery pack including a plurality of secondary batteries may be used as a power source for driving a motor of a hybrid vehicle or an electric vehicle and as a battery for power storage.

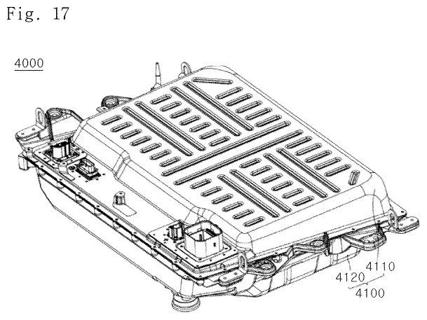

Hereinafter, a battery module including secondary batteries according to embodiments will be described with reference to FIG. 16.

Referring to FIG. 16, the battery module 3000 according to one or more example embodiments of the present disclosure include terminal parts 810 and 820, a plurality of secondary battery 2000 arranged in one direction, a connection tab 20 connecting a secondary battery 2000a to an adjacent secondary battery 2000b, and a protection circuit module 30 having one end connected to the connection tab 20. The protection circuit module 30 may include a battery management system (BMS). Further, the connection tab 20 may include a body portion in contact with the terminal parts 810 and 820 between the adjacent secondary battery 2000a and 2000b and an extension portion extending from the body portion and connected to the protection circuit module 30. The connection tab 20 may be, for example, a bus bar.

Each secondary battery 2000 may include a battery case, an electrode assembly received (or accommodated) in the battery case, and an electrolyte. The electrode assembly and the electrolyte react electrochemically to store and release (e.g., generate) energy. Terminal parts 810 and 820 electrically connected to the connection tab 20 and a vent 850 as a discharge passage for gas generated inside the battery case may be provided on one side of (e.g., an upper side in the orientation shown of) the secondary battery 2000. The terminal parts 810 and 820 of the secondary battery 2000 may be a positive electrode terminal 810 and a negative electrode terminal 820 having different polarities from each other, and the terminal parts 810 and 820 of the adjacent secondary battery 1000a and 1000b may be electrically connected to each other in series or parallel by the connection tab 20, to be described in more detail below. Although a serial connection has been described as an example, various connection structures may be employed as desired or necessary. In addition, the number and arrangement of secondary batteries may be changed as desired or necessary.

The plurality of secondary batteries 2000 may be arranged in (e.g., may be stacked in) one direction so that the wide surfaces of the secondary batteries 2000 face each other, and the plurality of secondary batteries 2000 may be fixed by the housings 61, 62, 63, and 64. The housings 61, 62, 63, and 64 may include a pair of end plates 61 and 62 facing the wide surfaces of the secondary battery batteries 2000 and a side plate 63 and a bottom plate 64 connecting the pair of end plates 61 and 62 to each other. The side plate 63 may support side surfaces of the secondary batteries 2000, and the bottom plate 64 may support bottom surfaces of the secondary batteries 2000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which a plurality of the secondary batteries 1000a and 1000b are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 2000 along the direction in which the plurality of secondary batteries 2000 are arranged, and the second protection circuit module 30b extends to the other upper side of the plurality of secondary batteries 2000 along the direction in which the plurality of secondary batteries 2000 are arranged. The second protection circuit module 30b may be spaced from the first protection circuit module 30a at a suitable or desired interval (e.g., a predetermined interval) with the vents 850 interposed therebetween but may be disposed parallel to the first protection circuit module 30a. As such, the two protection circuit modules are spaced from each other side-by-side along the direction in which the plurality of secondary batteries 1000a and 1000b (e.g., all the batteries) are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electrical wire. In addition, the connection member 50 may be made of or include a material having elasticity or flexibility. By the connection member 50, it may be possible to check and manage whether the voltage, temperature, and/or current of the plurality of secondary battery 2000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 2000 swells, shocks may be absorbed by the elasticity or flexibility of the connection member 50, thereby hindering or preventing the first and second protection circuit modules 30a and 30b from being damaged.

In addition, the shape and structure of the connection member 50 may vary from the shape and structure shown in FIG. 16.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

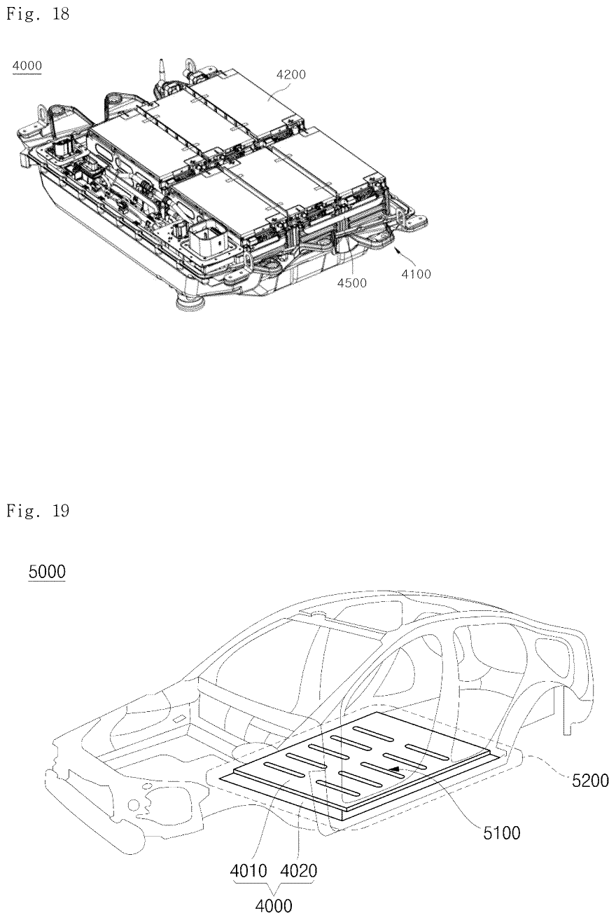

FIGS. 17 and 18 show a battery pack 4000 according to one or more example embodiments of the present disclosure. The battery pack 4000 may include a plurality of battery modules 4200 and a housing 4100 for accommodating the plurality of battery modules 4200. For example, the housing 4100 may include first and second housings 4110 and 4120 coupled in opposite directions through the plurality of battery modules 4200. The plurality of battery modules 4200 may be electrically connected to each other by using a bus bar 4500, and the plurality of battery modules 4200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 4300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

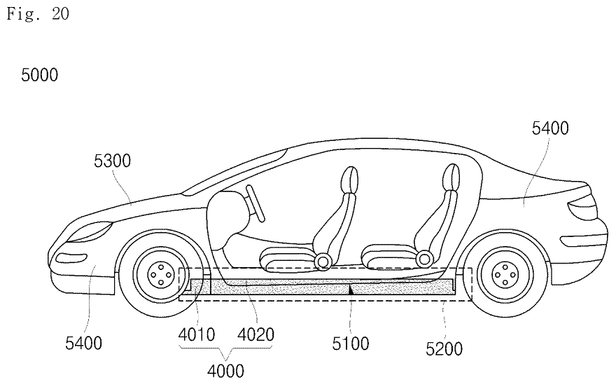

In FIG. 19, a battery pack 4000 may include a battery pack cover 4010, which is a part of a vehicle underbody 5100 and may correspond to the first housing, and a pack frame 4020, which is disposed under the vehicle underbody 5100 and may correspond to the second housing. The battery pack cover 4010 and the pack frame 4020 may be, e.g., integrally formed with a vehicle floor 5200. The vehicle underbody 5100 separates the inside and outside of a vehicle, and the pack frame 4020 may be disposed outside the vehicle

In FIG. 20, a vehicle 5000 may be formed by combining additional parts, such as a hood 5300 in front of the vehicle 5000 and fenders 5400 respectively located in the front and rear of the vehicle 5000 to a vehicle body part. The vehicle 5000 may include the battery pack 4000 including the battery pack cover 4010 and the pack frame 4020, and the battery pack 4000 may be coupled to the vehicle body part.

The electrode assembly according to the embodiments may include a plurality of electrode parts.

The plurality of electrode parts may be formed individually and sequentially laminated. Therefore, the meandering defect that may occur when manufacturing a large-sized electrode assembly may be reduced.

The meandering of the electrode assembly is defined as the degree of misalignment between the first electrode plate and the second electrode plate. If the misalignment between the first electrode plate and the second electrode plate increases, the meandering defect of the electrode assembly occurs. Accordingly, the charge/discharge characteristics of the electrode assembly may be reduced.

The meandering defect may increase as the size of the electrode assembly increases. The electrode assembly according to the embodiment is formed by forming a plurality of electrode parts and then laminating the electrode parts. Therefore, the meandering angle of each electrode part decreases. Accordingly, the meandering angle of the electrode assembly may also be reduced. Therefore, the electrode assembly according to the embodiment may have improved capacity and charge/discharge characteristics.

The electrode parts may be formed by the same or different stacking processes. For example, the electrode parts may be formed by two stacking processes. Therefore, since an appropriate stacking process is applied depending on the position of the electrode parts, the characteristics of the electrode assembly may be improved.

The size and/or direction of the meandering angle of each electrode part may be different. Accordingly, the meandering defect of the electrode assembly may be prevented. For example, even if the meandering angle of one electrode part increases, the meandering angle of another electrode part may be reduced to offset the meandering angle of one electrode part. Also, since the meandering directions of the plurality of electrode parts are different, the overall meandering angle of the electrode assembly may be reduced. Therefore, the electrode assembly according to the embodiment may have improved meandering characteristics.

The above is only an example embodiment for implementing a secondary battery according to the disclosure, and other embodiments may vary, and there is a technical spirit of the disclosure to the extent that various modifications can be made by anyone having ordinary skill in the art to which the disclosure pertains without departing from the gist of the disclosure as claimed in the following claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a plurality of electrode parts comprising a first electrode plate, a second electrode plate, and a separator; and
a fixing member surrounding the plurality of electrode parts,
wherein the plurality of electrode parts have a meandering angle of 0.1° or less, and
wherein the meandering angle is an angle at which a lowermost electrode plate and an uppermost electrode plate of the plurality of electrode parts are misaligned.

2. The electrode assembly as claimed in claim 1, wherein the plurality of electrode parts comprise a first electrode part, a second electrode part on the first electrode part, and a third electrode part on the second electrode part, and wherein:
the first electrode part comprises a first electrode plate, a second electrode plate, and a first separator between the first electrode plate and the second electrode plate,
the second electrode part comprises a third electrode plate, a fourth electrode plate, and a second separator between the third electrode plate and the fourth electrode plate,
the third electrode part comprises a fifth electrode plate, a sixth electrode plate, and a third separator between the fifth electrode plate and the sixth electrode plate, and
the meandering angles of the first electrode part, the second electrode part, and the third electrode part are different from each other.

3. The electrode assembly as claimed in claim 2, wherein:
the electrode assembly comprises an overlapping separator, and
a thickness of the overlapping separator is greater than a thickness of another separator of the first separator, the second separator and the third separator.

4. The electrode assembly as claimed in claim 3, wherein the overlapping separator is formed separators of different electrode parts of the plurality of electrode parts.

5. The electrode assembly as claimed in claim 4, wherein the overlapping separator is in a boundary region of the different electrode parts.

6. The electrode assembly as claimed in claim 2, wherein:
the first separator comprises a first separator part and a second separator part,
the second separator comprises a third separator part and a fourth separator part,
the third separator comprises a fifth separator part and a sixth separator part,
the first separator part, the third separator part and the fifth separator part are disposed between the first electrode plate and the second electrode plate, and
wherein the second separator part, the fourth separator part and the sixth separator part are on side surfaces of the first electrode plate and the second electrode plate, resulting in separator parts, and
wherein at least two separator parts among the second separator part, the fourth separator part and the sixth separator part form a side overlapping separator.

7. The electrode assembly as claimed in claim 6, wherein a length of the side overlapping separator is longer than a length of other of the separator parts.

8. The electrode assembly as claimed in claim 6, wherein the side overlapping separator is on a boundary region of the plurality of electrode parts.

9. The electrode assembly as claimed in claim 2, wherein the first electrode part, the second electrode part, and the third electrode part are formed by the same stacking process.

10. The electrode assembly as claimed in claim 9, wherein the first electrode part, the second electrode part, and the third electrode part are stacked in a Z stack.

11. The electrode assembly as claimed in claim 2, wherein:
the first electrode part and the third electrode part are outer electrode parts,
the second electrode part is an inner electrode part, and
the first electrode part and the third electrode part are formed by a stacking process different from the second electrode part.

12. The electrode assembly as claimed in claim 11, wherein:
the first electrode part and the third electrode part are stacked, and
the second electrode part is stacked in a Z stack.

13. The electrode assembly as claimed in claim 11, wherein:
the first electrode part and the third electrode part are stacked in a Z stack, and
the second electrode part is stacked.

14. The electrode assembly as claimed in claim 2, wherein:
the first electrode part has a first thickness,
the second electrode part has a second thickness,
the third electrode part has a third thickness, and
the first thickness, the second thickness, and the third thickness are different.

15. The electrode assembly as claimed in claim 14, wherein thicknesses of the plurality of electrode parts decrease or increase while extending from the first electrode part toward the third electrode part.

16. The electrode assembly as claimed in claim 1, wherein at least one electrode part has a material of a separator, a material of an electrode current collector, or an electrode active material different from other of the plurality of electrode parts.

17. The electrode assembly as claimed in claim 2, wherein meandering angles of the plurality of electrode parts decrease or increase while extending from the first electrode part toward the third electrode part.

18. The electrode assembly as claimed in claim 2, wherein the electrode assembly comprises a region in which a meandering direction of the plurality of electrode parts changes while extending from the first electrode part toward the third electrode part.

19. The electrode assembly as claimed in claim 1, wherein the electrode assembly has a thickness of 40 mm to 50 mm.

20. A secondary battery comprising;
a case; and
the electrode assembly as claimed in claim 1 accommodated in the case.
